(19) United States
(12) Patent Application Publication
(10) Pub. No.: US 2005/0284010 A1
(43) Pub. Date: Dec. 29, 2005

(54) Customizable lenticular display and indicia carrier

(76) Inventor: Izhak Bar-Yona, Rosh Haayin (IL)

Correspondence Address: Kevin D. McCarthy;Roach Brown McCarthy & Gruber, P.C., 1620 Liberty Building, 420 Main Street, Buffalo, NY, 14202, US

(21) Appl. No.: 11/166,318

(22) Filed: Jun. 24, 2005

(30) Foreign Application Priority Data
Jun. 28, 2004 (IL) 162758

(51) Int. Cl. G03B 25/02

(52) U.S. Cl. 40/454

(57) ABSTRACT

The invention is a customizable lenticular display unit. The display unit comprises a supporting frame, a transparent lenticular panel, an indicia carrier printed with lithographic interlaced images, and drive means for periodically displacing the indicia carrier relative to the lenticular panel. The supporting frame has one or more openings in its back surface that can be closed by detachable covers. The indicia carrier comprises one or more windows corresponding to the size, shape and location of the openings in the supporting frame. A non-interlaced simple print or photo image selected by the end user is positioned onto the detachable cover/s resulting in a customizable display. When the motor is activated, the display will comprise animated visual effects that have been professionally and industrially created in advance and a static image that will have special meaning for the owner of the display unit. The invention is also a customizable indicia carrier comprising one or more windows having a given form, located inside of the printed area to be used with dynamic lenticular display units.

### FIELD OF THE INVENTION

The present invention relates to the field of display devices. More particularly, the invention relates to a display device that generates alternately revealed images by using a customized indicia carrier.

### BACKGROUND OF THE INVENTION

Multi-image display devices of various kinds are known. Such devices are suitable for advertisements, instructional purposes, promotional devices, games, and many other uses. Many of such devices require a substantial amount of electrical power for their operation, and are therefore connected to a constantly operating source of alternating current. Many of such devices are relatively large, due to the relative complexity of the required drive means and other parts thereof.

U.S. Pat. No. 6,226,906 by the inventor of the present application, the description of which, including reference cited therein, is incorporated herein by reference in its entirety, discloses a self-powered display unit of reduced size for displaying at least two consecutively changing images to be viewed by a viewer. The unit comprises a housing, an array of linear lenses having a lenticular front face and a flat rear face, a displaceable, light-weight and substantially planar indicia carrier located in a cavity between the lenticular panel and the back of the housing at a distance from the rear face of the panel at most equaling the focal length of the lenses, and a high efficiency, low energy consumption, battery-powered DC drive means for periodically displacing the indicia carrier a distance at least equaling the distance between two adjacent lenses of the array.

Indicia carriers of dynamic lenticular displays are generally factory-produced and are procured on a large-scale basis. At times, a consumer desires to display a personally selected image. However, the cost of a single customized indicia carrier is prohibitive, due to the high manufacturing costs associated with the design work of a graphic artist, with the development of the resulting photograph, with the production of a pilot print and with the labor costs of skilled laborers. A need therefore exists for a cost-effective customizable indicia carrier.

It is an object of the present invention to provide a customizable indicia carrier.

It is an additional object of the present invention to provide a customizable indicia carrier that is cost effective.

It is an additional object of the present invention to provide a customizable indicia carrier that may be produced without any skilled labor.

It is an additional object of the invention to provide a customized lenticular display unit integrating a simple image photo with multi images presentation.

Other objects and advantages of the invention will become apparent as the description proceeds.

### SUMMARY OF THE INVENTION

In this application the following definitions are used:
“A lenticular sheet or panel” is a transparent plastic sheet or panel having a flat rear face and a front face comprising a plurality of linear lenses.
“An interlaced image” is a graphical image composed of one or more basic images in a way that when applied to the rear face of a lenticular sheet, the basic images are observed at different viewing angles.
“An interlaced indicia carrier” is a plastic or paper sheet, on which an interlaced image is printed.
“A dynamic lenticular display unit” is a display unit comprising a front stationary lenticular panel and a rear indicia carrier that is periodically moving relative to the front lenticular panel.
“A customizable indicia carrier” is an indicia carrier in which at least part of its content is prepared by the end user according to his own choice.
“A customizable lenticular display unit” is a lenticular display unit, in which at least a part of its content is created by the end user, according to his own choice.
   In a first aspect the invention is a customizable lenticular display unit. The display unit comprises:
(a) a supporting frame having one or more openings in its back surface;
(b) one or more detachable covers that fit into the openings;
(c) a transparent lenticular panel received into the supporting frame;
(d) an indicia carrier printed with lithographic interlaced images comprising one or more windows corresponding to the size, shape and location of the openings in the supporting frame; and
(e) drive means for periodically displacing the indicia carrier relative to the lenticular panel.
   When a non-interlaced simple print or photo image is positioned onto the detachable cover/s, a display comprising the combined presentation of static and animated images is observed.

The customizable lenticular display unit of the invention can comprise guiding means connected to the drive means and the indicia carrier can be attached to the guiding means. In one embodiment the drive means comprises a small, low power consumption motor with an eccentric cam attached to its shaft. In embodiments that do not comprise guiding means, the indicia carrier is coupled to or rests on the eccentric cam.

In some embodiments the lenticular panel can be removed to allow the end user to replace the indicia carrier and in other embodiments the lenticular panel cannot be removed, and the end user cannot replace the indicia carrier. The display unit may also comprise a removable front panel.

The lenticular panel may comprise one or more clear transparent areas in which no lenses are embossed, the clear areas being substantially the size, shape, and location of the windows in the indicia carrier. The shape of the opening/s can be selected from the group comprising: round, elliptical, polygonal, and amorphous.

In another aspect the invention is a customizable indicia carrier to be used with dynamic lenticular display units. The indicia carrier of the invention comprises a plastic or paper sheet on which an interlaced image comprising at least two basic images is printed. The indicia carrier of the invention is characterized in that it comprises one or more windows having a given form, located inside of the printed area.

The window/s can be created by cutting out one or more portions of the sheet or by printing the interlaced image on a transparent sheet and not printing the portion/s of the interlaced image that occur/s at the location/s of the window/s. The shape of the window/s may be selected from the group comprising: round, elliptical, polygonal, and amorphous.

All the above and other characteristics and advantages of the invention will be further understood through the following illustrative and non-limitative description of preferred embodiments thereof, with reference to the appended drawings.

### BRIEF DESCRIPTION OF THE DRAWINGS

FIG. 1 and FIG. 2 show front and rear perspective views respectively of a dynamic lenticular display unit comprising a customized indicia carrier according to the invention;

FIG. 3 to FIG. 5 describe the steps that are followed to create a customized indicia carrier of the invention;

FIG. 6 is a front perspective view of the dynamic lenticular display unit described with respect to FIGS. 1 to 5;

FIG. 7 a cross-sectional view of another embodiment of a dynamic lenticular display unit, which comprises a customized indicia carrier according to the invention;

FIG. 8 and FIG. 9 show respectively front and rear perspective views of another embodiment of a display unit, which comprises a customized indicia carrier according to the invention;

FIG. 10 is a perspective front view of the unit with its internal parts exposed; and

FIG. 11 is a vertical cross sectional view of the display unit of FIG. 8.

### DESCRIPTION OF PREFERRED EMBODIMENTS

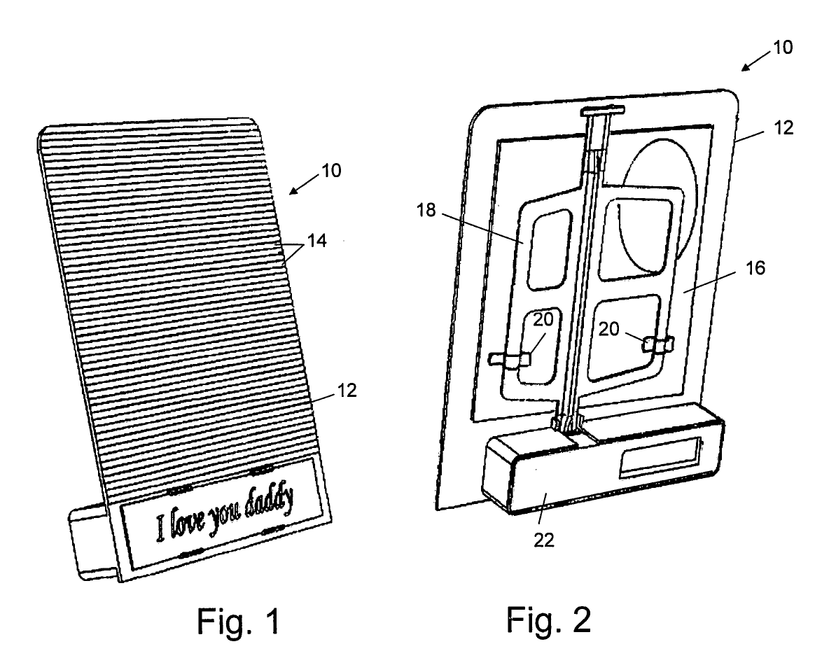

FIG. 1 and FIG. 2 show front and rear perspective views respectively of a dynamic lenticular display unit 10, which comprises a customized indicia carrier according to the invention. Display unit 10 comprises a front lenticular panel 12, having an array of horizontal linear lenses 14. An indicia carrier 16 in a form of a lightweight sheet of plastic or paper is inserted between panel 12 and guiding means 18. Guiding means 18 can be periodically moved up and down along a vertical axis, as will be described hereinbelow. The indicia carrier 16 has one or more small holes created in it during the printing process and guiding means 18 have two or more small pins located on them (neither the pins nor the holes are shown in the figures). Placing the holes over the pins assures proper alignment of the print with the lenses. Small strips of adhesive tape 20 are used to hold indicia carrier 16 on guiding means 18 such that indicia carrier 16 will move vertically when guiding means 18 is caused to move.

A self powered, geared motor and a battery (not shown in FIG. 1 or FIG. 2), which are contained in a rear compartment 22 supply the force needed to move guiding means 18.

If indicia carrier 16 has been correctly prepared following known lenticular interlacing methods, then the basic images 26 will be alternately displayed on lenticular panel 12 when the relative movement takes place.

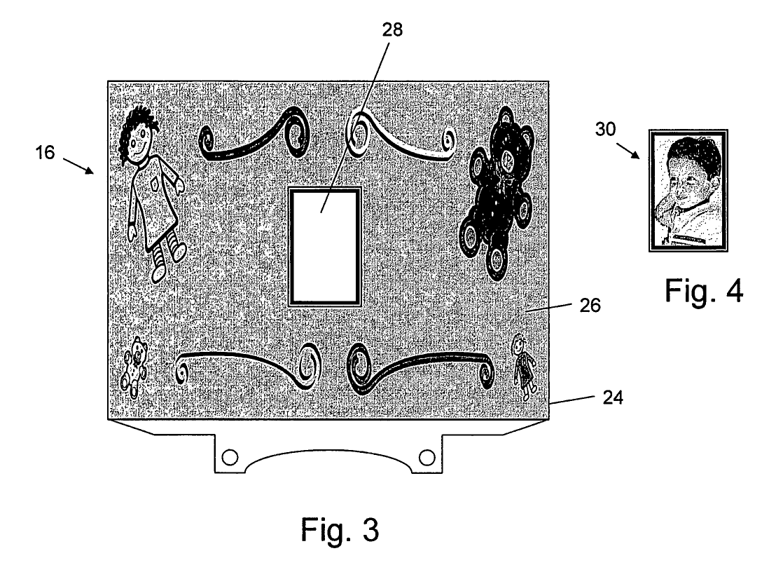

FIG. 3 to FIG. 5 describes the steps that are followed, according to the invention, to create a customized indicia carrier use in display unit 10.

The first step, shown in FIG. 3, consists of creating indicia carrier 16 in the form of a lightweight sheet 24, by printing an interlaced image comprising two or more basic images 26 on its front side, and then creating a window 28 by cutting out a portion of the sheet 24. Note that for clarity, in the figures showing the indicia carrier is portrayed with a single one of the basic images shown and not with the interlaced image that is actually present. In the example shown in the figures, window 28 has a rectangular shape, but any desired shape, e.g. round, elliptical, polygonal, or amorphous can be used. Instead of actually cutting the portion out of the indicia carrier in order to create window 28 an equivalent result can be obtained by using a transparent sheet 24 and printing the interlaced image upon it except in the location of window 28, which is left unprinted.

Image processing methods for lenticular technology, are well known in the art, e.g. U.S. Pat. No. 6,542,646, by the inventor of the present invention and U.S. Pat. No. 5,494,445 by Sekiguchi, et al. disclose different methods for creating an interlaced print out of two or more given basic images. Therefore no detailed description for the interlacing method itself will be given herein.

While the step shown in FIG. 3 is professionally executed, the end-user himself accomplishes the second step, shown in FIG. 4. Having an indicia carrier 16 such as the one shown in FIG. 3, he selects a photograph or print image 30 that he desires to include in the display and trims it until its size and shape are substantially equal to that of window 28. The image chosen can be of any nature, e.g. personal, a logo, or an advertisement.

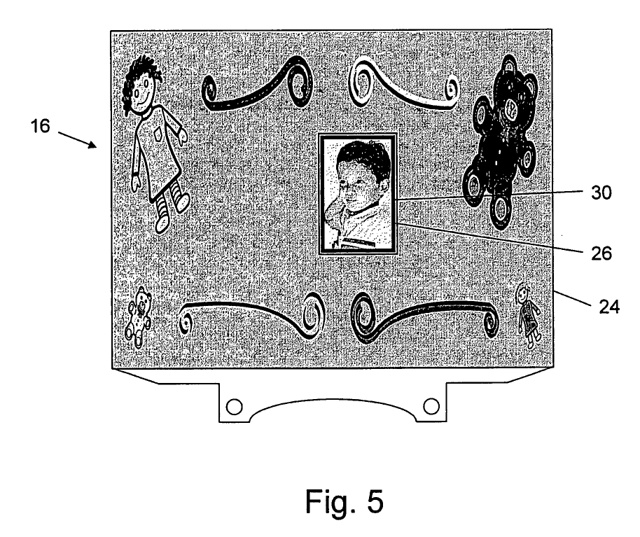

The third step consists of attaching photo image 30 to the rear face of indicia carrier 16 so that, when the display is activated, the subject of photo 30 can be clearly observed, surrounded by the basic image 26, as seen in FIG. 5. This step can be accomplished, for example by using transparent glue or strips of adhesive tape.

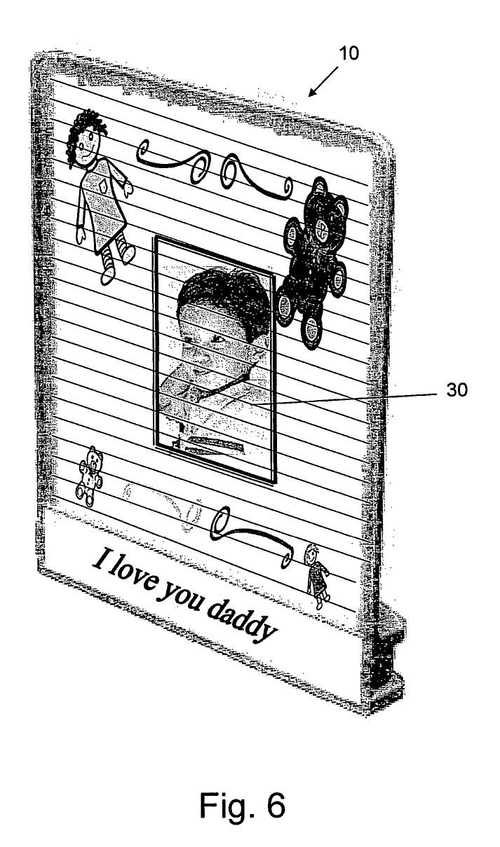

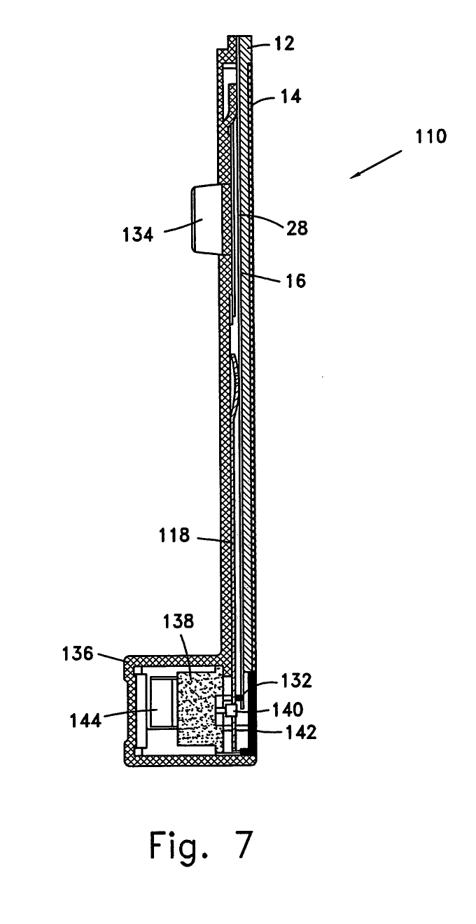

The customized indicia carrier is now installed, as described hereinabove, in a dynamic display unit, e.g. the one shown in FIG. 1 and FIG. 2. The result, shown in FIG. 6, is a customizable display 10 made unique by the end user. When the motor is activated, the display will comprise animated visual effects that have been professionally and industrially created in advance and a static image that will have special meaning for the owner of the display unit. It is the role of the designer to illustrate the basic images 26 so that the animated video-effect, seen on the display screen will complement the stationary image 30, seen through the lenses.

Another embodiment of a dynamic lenticular display unit 110, which comprises a customized indicia carrier according to the invention, is illustrated in a cross-sectional view in FIG. 7.

The structure and method of operation of this embodiment will be described mainly with reference to FIG. 7. The display unit 110 comprises a rigid plastic frame 136, which supports the remaining components. In the base of frame 136 is a compartment in which are located a small, low power consumption geared motor 138. The motor can be driven by any suitable power source 144, e.g. a battery, mains power, or energy supplied by a small solar panel. On the shaft of motor 138 is attached an eccentric cam 140, which fits into a slot in guiding means 118. Activation of motor 138 causes rotation of cam 140, which causes guiding means 118 to have a periodic up and down motion.

Projecting out of the bottom of guiding means 118 are two or more pins 132 for attaching the indicia carrier 16 to guiding means 118. Next a customized indicia carrier 16, which comprises a window 28 and has been prepared as described hereinabove, is fitted over pins 132. Finally, lenticular front panel 12 is attached to frame 136 by any suitable method, such as clasps, glue, or welding. When the motor is activated, the indicia carrier 16, which is attached to guiding means 118, will move up and down in the between two vertical planes defined by rigid frame 118 and guiding means 118 on its back side and the lenticular panel 12 on its front side. The cyclic vertical displacement of the indicia carrier 16 relative to the fixed lenses 14 will cyclically reveal the basic images 26 on the front of the display. If desired, the bottom front of the frame can be closed with a removable front cover 142 to provide access to the motor and power supply.

On the backside of frame 134, overlying window 28 in indicia carrier 16, is an opening closed by a cover 134. A personal photo image 30, which is inserted into cover 134 by the end user, can be seen through the window 28 of moving indicia carrier 16, thereby creating the customized display shown in FIG. 6.

In the preferred embodiment, the assembly of the display unit 110 is done in the factory to insure accurate alignment of the interlaced image printed on indicia carrier 16 with lenses 14. In this case, the indicia carrier cannot be replaced by the end user of the display. It is also possible to build embodiments of display unit 110 in which the indicia carrier 16 can be replaced. One way to do this is to make alignment holes in lenticular front panel 12 that also fit over pins (not shown in the figures) projecting from frame 136. When desired, the front panel 12 is first removed from the frame. Then indicia carrier 16 is removed from the pins 132 thereby disconnecting it from guiding means 118. A new indicia carrier is then installed and the lenticular panel reattached to the frame. In all embodiments of the display, the personal photo image 30 can be easily replaced with a different one as often as desired. In addition embodiments of the invention are envisaged in which the indicia carrier 16 has more than one window 28, thereby allowing the end user to customize his display with more then one photo image 30.

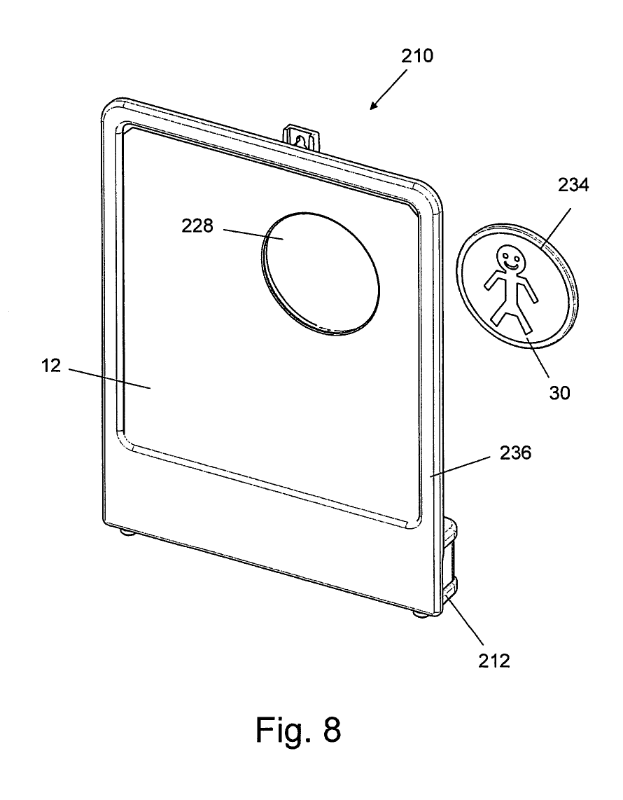

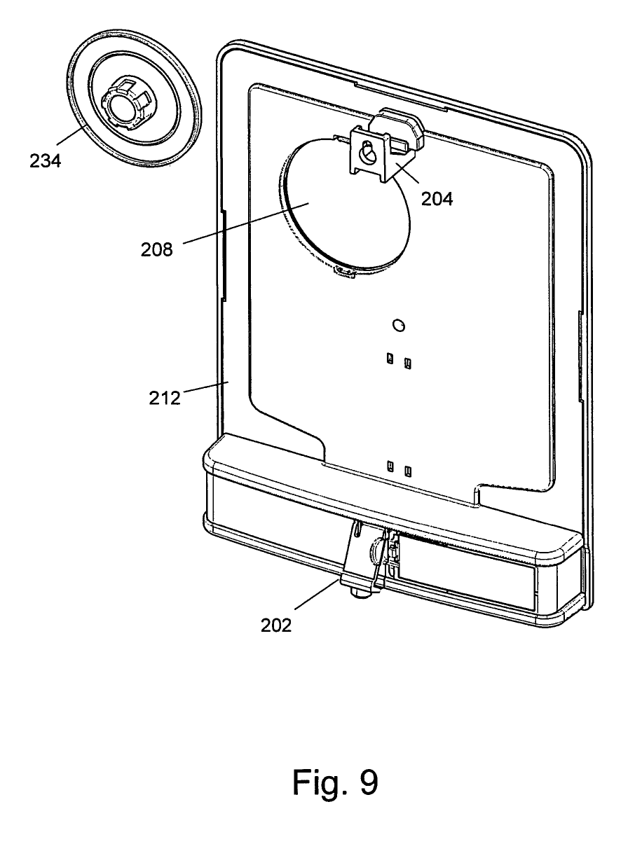

FIG. 8 and FIG. 9 show respectively front and rear perspective views of another embodiment of a display unit 210 according to the present invention.

Referring to FIG. 8, a display unit 210 according to this embodiment, comprises a front lenticular panel 12, having a window 228 comprising a clear transparent area, in which no lenses are embossed, and a decorative front panel 236, which holds lenticular panel 12 inside rear structural support 292 (see FIG. 9).

FIG. 9 shows rear structural support frame 292 comprising a detachable cover 234 which fits into opening 208. The customer can place his personal photo image 30 into detachable cover 234.

Display unit 210 can either stand on a horizontal surface, e.g. counter or desktop, or be hung on a wall. A foldable supporting leg 202 extends from main support 212, in order to stabilize the unit when placed on a counter, and an optional hanging means 204 is a part of main support frame 212, for use when hanging on the wall is the preferred option.

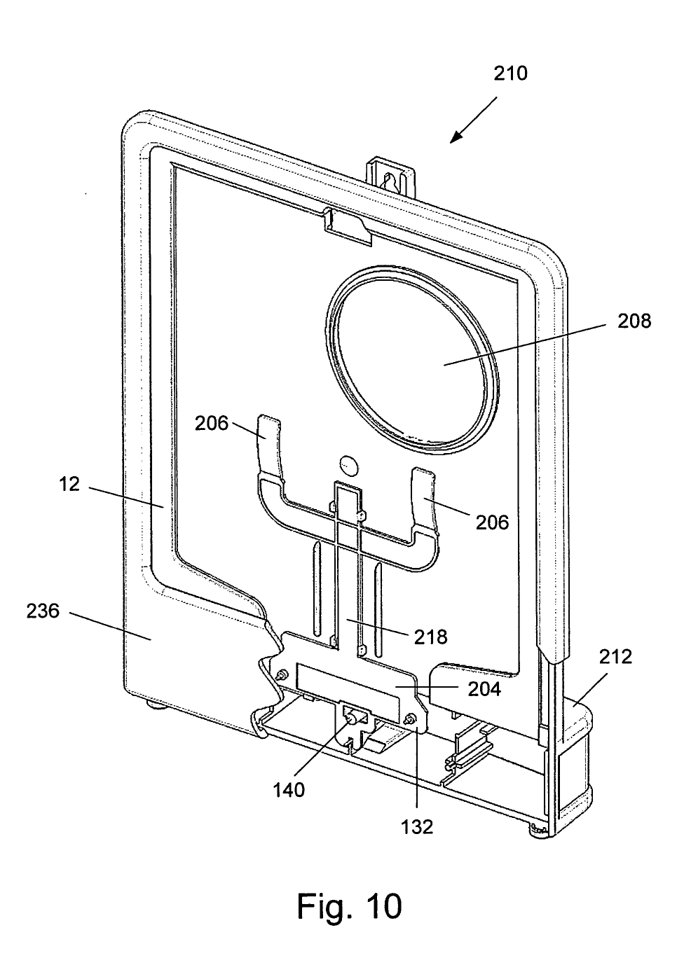

FIG. 10 is a perspective front view of the unit 210, wherein lenticular panel 12 and decorative frame 236 have been mostly removed in order to expose the internal parts of the unit. Guiding means 218 are seen connected to a rotating, eccentric cam 140, which causes them to be periodically displaced in a vertical direction. Guiding means 218 comprises two resilient areas 206 pressing against the rear flat side of lenticular panel 12.

In order to insert the indicia carrier (not shown in FIG. 10), front decorative frame 236 and lenticular panel 12 are initially removed from main support 212. The indicia carrier 16 of the invention, in the form of a lightweight sheet is put over resilient guiding means 218 and attached to lower horizontal section 204 of the guide means by pressure sensitive glue or tape or by inserting a couple of pins 132 into corresponding punctures prepared in advance during the process of preparing the indicia carrier 16. When lenticular panel 12 and decorative frame 236 are put back in their original locations, they press the indicia carrier 16 against two resilient areas 206 on guiding means 218.

As a result indicia carrier 16 is uniformly pressed against the rear face of lenticular panel 12, i.e. the interlaced image is held in the exact focal points of the lenses.

The end user can now add his personal photo 30 to rear, round, detachable part 234, and insert it into opening 208 in main support 238 so that it can be observed as a static, essential part of the dynamic presentation.

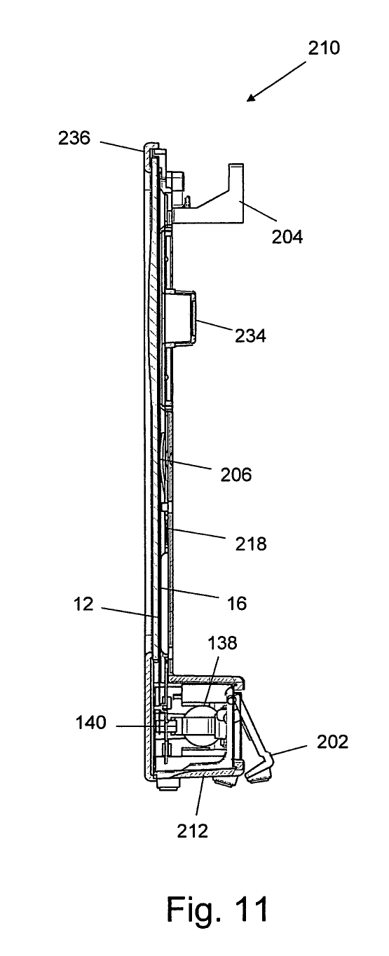

FIG. 11 is a vertical cross sectional view of display unit 210. In unit 210, front lenticular panel 12 is held by decorative frame 236, such that indicia carrier 16 is pressed against resilient areas 206 of guiding means 218. Guiding means 218 are connected to cam 140, which is rotated by a small geared motor 138 supported within rear support 212. Rear supporting leg 202, optional hanging means 204 and detachable rear round plate 234 are also shown in the figure connected to rear support 212.

It is important to note that the guiding means are not necessary and that the indicia carrier can rest on or be coupled to the eccentric cam and move up and down within a cavity defined by two panels, in the manner described in the above referenced U.S. Pat. No. 6,226,906. It is preferred however to use guiding means such as those in the display units 10, 110, and 210 described herein. By attaching the indicia carrier to the guiding means in the manner described, it is pushed against the rear flat face of lenticular panel by the resilient guiding means. As a result, the freedom of motion of the indicia carrier in a direction perpendicular to the plane of the lenses that is allowed in the prior art is eliminated and it is accurately positioned it at the focal points of the lenses. Therefore it is possible to make use of a higher resolution lens, such as 30 or even 40 lpi (lenses per inch), then can be used in the prior art display units.

Although embodiments of the invention have been described by way of illustration, it will be understood that the invention may be carried out with many variations, modifications, and adaptations, without departing from its spirit or exceeding the scope of the claims.

1. A customizable lenticular display unit comprising:
(a) a supporting frame having one or more openings in its back surface;
(b) one or more detachable covers that fit into said openings;
(c) a transparent lenticular panel received into said supporting frame;
(d) an indicia carrier printed with lithographic interlaced images comprising one or more windows corresponding to the size, shape and location of said openings in said supporting frame; and
(e) drive means for periodically displacing said indicia carrier relative to said lenticular panel;
wherein, when a non-interlaced simple print or photo image is positioned onto said detachable cover/s, a display comprising the combined presentation of static and animated images is observed.

2. A customizable lenticular display unit, according to claim 1, comprising guiding means connected to the drive means.

3. A customizable lenticular display unit, according to claim 2, wherein the indicia carrier is attached to the guiding means.

4. A customizable lenticular display unit, according to claim 1, wherein the drive means comprises a small, low power consumption motor with an eccentric cam attached to its shaft.

5. A customizable lenticular display unit, according to claim 4, wherein the indicia carrier is coupled to or rests on the eccentric cam.

6. A customizable lenticular display unit, according to claim 1, wherein the lenticular panel can be removed to allow the end user to replace the indicia carrier.

7. A customizable lenticular display unit, according to claim 8, wherein the lenticular panel cannot be removed, and the end user cannot replace the indicia carrier.

8. A customizable lenticular display unit, according to claim 1, wherein the lenticular panel comprises one or more clear transparent areas in which no lenses are embossed, said clear areas being substantially the size, shape, and location of the windows in the indicia carrier.

9. A customizable lenticular display unit, according to claim 1, comprising a removable front panel.

10. A customizable lenticular display unit, according to claim 1, wherein the shape of the opening/s is/are selected from the group comprising: round, elliptical, polygonal, and amorphous.

11. A customizable indicia carrier to be used with dynamic lenticular display units comprising a plastic or paper sheet on which an interlaced image comprising at least two basic images is printed;
characterized in that said indicia carrier comprises one or more windows having a given form, located inside of the printed area.

12. A customizable indicia carrier according to claim 11, wherein said window/s is/are created by cutting out one or more portions of the sheet.

13. A customizable indicia carrier according to claim 11, wherein said window/s is/are created by printing the interlaced image on a transparent sheet and not printing the portion/s of said interlaced image that occur/s at the location/s of said window/s.

14. A customizable indicia carrier according to claim 11, wherein the shape of the window/s is/are selected from the group comprising: round, elliptical, polygonal, and amorphous.
